(19) United States
(12) Patent Application Publication
(10) Pub. No.: US 2006/0036590 A1
(43) Pub. Date: Feb. 16, 2006

(54) System and method for documenting a multi-media conversation

(76) Inventors: Farrokh Mohammadzadeh Kouchri, Boca Raton, FL (US); Bizhan Karimi-Cherkandi, Boca Raton, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/201,340

(22) Filed: Aug. 10, 2005

Related U.S. Application Data
(60) Provisional application No. 60/600,256, filed on Aug. 10, 2004.

(51) Int. Cl. G06F 17/30

(52) U.S. Cl. 707/3

(57) ABSTRACT

A multi-media documenter and methods for documenting a communication session among participants is provided so that manual entry of information is minimized. Session information including multi-media information may be captured automatically from participants, when available, through the use of templates. Information may be automatically captured from profiles at communication devices or entered by users. In this way, a record may be captured for communications sessions such as a telephonic call that documents the particulars associated with the session such as participants' names, date, a transcription of the conversation, pictures, video, animation, text and the like.

### CROSS-REFERENCE TO RELATED APPLICATIONS

This application claims priority under 35 U.S.C. §119(e) to provisional U.S. Patent Application No. 60/600,256, filed on Aug. 10, 2004, the disclosure of which is expressly incorporated by reference herein in its entirety.

### BACKGROUND OF THE INVENTION

1 . Field of the Invention

The invention is directed to a system and method for documenting communication sessions and, more particularly, to a system and method for documenting communication sessions between two or more participants including multi-media components.

2. Related Art

Communications, including telephony, are relied upon for routine commercial and non-commercial business interactions for various organizational related reasons and have evolved to be core enablers for enterprise operations overall, as well as for individuals within the enterprise to perform respective functional tasks. These enablers include real-time communications such as conference calls, video conferences, project collaboration, agenda setting, business planning, ordering functions, and the like. Unfortunately, the content of many telephonic based business activities are often lost, or inadequately documented, resulting in undesirable consequences such as, for example, business inefficiencies, loss of opportunities, inability to archive phone calls and basic errors causing inaccuracies.

Human nature often contributes to the general lack of adequate documentation of telephonic conversations and meetings, which may be attributable to motivational issues or management issues, but also attributable to an inadequate predefined or enforced structure/environment to accurately capture and disseminate the contents of telephonic proceedings.

Historically, indexed proceedings of telephonic communications are rarely compiled so that business operations are not able to systematically reference communications content that may have occurred over time. Moreover, there is a paucity of automation products currently available that can record, index and store context of conversations for efficient archival and retrieval reasons; particularly if the conversations include multimedia content such as text files, video or animation.

In operational situations such as call centers, for example, the agent or operator fielding an incoming call, perhaps to log an customer accident incident in a case of an insurance claims center, typically prompts the caller for certain information such as personal data, description of the accident, name of insured, and the like. These pieces of information are typically converted manually by the operator to an electronic or paper document. Some data may in turn be returned to the caller such as a claim number or tracking number. This manual process tends to lead to inaccuracies and can become tiresome for the agent and/or caller. Moreover, the caller may also want to document the conversation but is typically forced to a manual mode of recording information. Because of the two independent manual operations, the information recorded at each side may not be identical and may even be contradictory. Even if the conversation is audibly recorded, the content of the record is not parameterized and hence not elementally accessible (e.g., the name of the client is somewhere in the record, but is not directly indexable). In the case of a recorded conversation, a caller rarely, if ever, receives a transcript or document relating to the conversation.

Accordingly, there is a need for a system and method to automatically, or under select control of a designated agent (human or non-human), to control the acquisition of communication or telephonic proceedings for indexing, recording, storing, retrieval, searching and propagation of the proceedings, as necessary.

### SUMMARY OF THE INVENTION

The invention meets the foregoing need and provides for documenting a communication session among participants so that manual entry of information is minimized, although still provisioned, and session information including multi-media information may be captured automatically from participants, when available, through the use of predefined or dynamic templates. The system and methods of the invention are generally referred to herein as a Multi-media Communications Documenter (MCD) which produces a document referred to as a pDoc.

In an aspect of the invention, a method for documenting a communications interchange is provided. The method comprises providing to a first communications device a template defining at least one element for capturing information and processing the template at the first communications device so that at least one query is issued to a second communications device based on the at least one defined element. The method further comprises receiving at least one response to the at least one query including information responsive to the at least one defined element and creating a document based on the information received.

In another aspect of the invention, a method for documenting a communication session is provided. The method comprises receiving at a first communications device a multimedia conversation documenter (MCD) invitation request and sending to a second communications device an acknowledgement to the MCD invitation request accepting participation in documenting the communication session. The method further comprises receiving at the first communication device a query that includes a tag that identifies an element and issuing to the second communications device a reply to the query that includes information relevant to the element.

In yet another aspect of the invention, a system for documenting a communications session is provided. The system comprises a first communication device that issues at least one query according to a template that defines at least one element for requesting and acquiring information during the communications session. The at least one query includes at least one tag indicative of the type of information being requested. The system further includes a second communications device to translate said at least one query and return information corresponding to said at least one element during the communications session.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1A is a block diagram of an exemplary environment of the invention;

FIG. 1B is a block diagram of another exemplary environment of the invention;

FIG. 2 is a block diagram of yet another exemplary environment of the invention;

FIG. 3 is relational flow diagram showing a first embodiment of a process of documenting an illustrative call interchange, according to principles of the invention;

FIG. 4 is a relational flow diagram of a second embodiment of a process of documenting an illustrative call interchange, according to principles of the invention;

FIG. 5 is a relational flow diagram of a third embodiment of a process of documenting an illustrative call interchange, according to principles of the invention;

FIG. 6 is a flow diagram showing steps for constructing a template, according to principles of the invention;

FIG. 7 is a flow diagram of an embodiment showing steps of documenting a communications session, according to principles of the invention; and

FIG. 8 is a flow diagram of another embodiment showing steps of documenting a communications session, according to principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

The system and methods of the invention provide for documenting a communication session among participants so that manual entry of information is minimized, although still provisioned, and session information including multi-media information may be captured automatically from participants, when available, through the use of predefined or dynamic templates. The system and methods of the invention are generally referred to herein as a Multi-media Communications Documenter (MCD) which produces a document referred to as a pDoc.

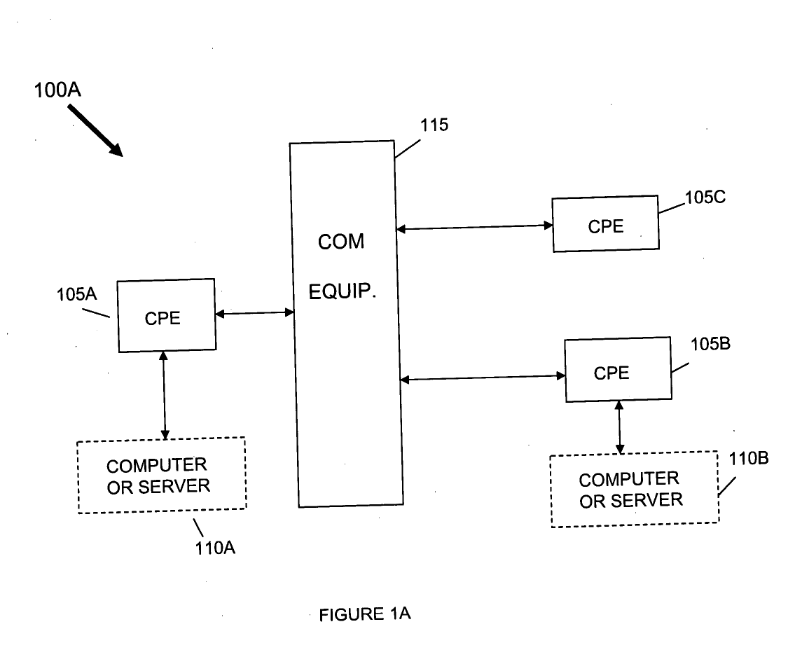

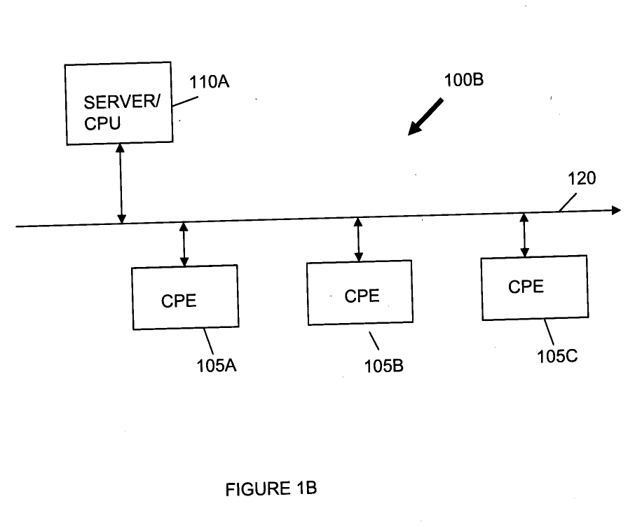

FIG. 1A is a block diagram of an exemplary system environment of the invention, generally denoted by reference numeral 100A. The exemplary environment includes a plurality of intelligent customer premise equipment (CPE) devices 105A-105C, which may be intelligent telephones or may be other intelligent computing devices capable of general communications such as cell phones, switches, personal computers, and the like. The CPEs 105A-105C may support various types of communication exchange such as voice, data, video or encrypted data, depending on the capabilities of the particular type of communications device. The exemplary environment 100A may also optionally include one or more computers or servers 110A, 110B in communication with CPE 105A, 110B. The optional computer or server 110A, 110B provides for downloading templates to the CPE 105A, 105B, as necessary, and in some embodiments, to store records developed by the MCD, as well as downloading MCD functionality. CPE 110C is shown as a standalone device that has been pre-loaded or dynamically loaded with MCD functionality and templates.

The exemplary environment 100A also includes communications equipment 115 suitable for interconnecting the plurality of CPEs 105A-105C. For example, the communications equipment 115 may include a telephone network, a private branch exchange (PBX), a switch, a network or a combination of networks, such as the Internet. The CPEs 105A-105C may be commonly controlled by communications equipment 115, or the communications equipment 115 may simply provide session connectivity (e.g., a voice and/or data channel) to the CPEs 105A-105C without direct control over the CPEs 105A-105C.

FIG. 1B is a block diagram of another exemplary environment of the invention, generally denoted by reference numeral 100B. This exemplary environment 100B shows a network 120 based communications system with a server or CPU 110A in communication with the CPEs 105A-105C. The server or CPU 110A may provide the functional control over the CPEs, perhaps using Session Initiated Protocol (SIP) protocol, for example. In this environment the voice and data may be borne across the network 120, along with control signaling. In some embodiments, the environment 100B might also include (not shown) interfaces to other networks such as the Internet, PBXs or the public telephone network. The CPEs 105A-105C may have MCD functionality pre-loaded, or alternatively, may receive downloads as necessary from the server or CPU 110A. The server or CPU 110A may also store results of the MCD operations, as explained below. The CPEs 105A-105C may also support digital voice and signaling protocols such as voice-over-Internet protocol (VOIP). Moreover, the CPEs 105A-105C may also support wireless and video communications standards.

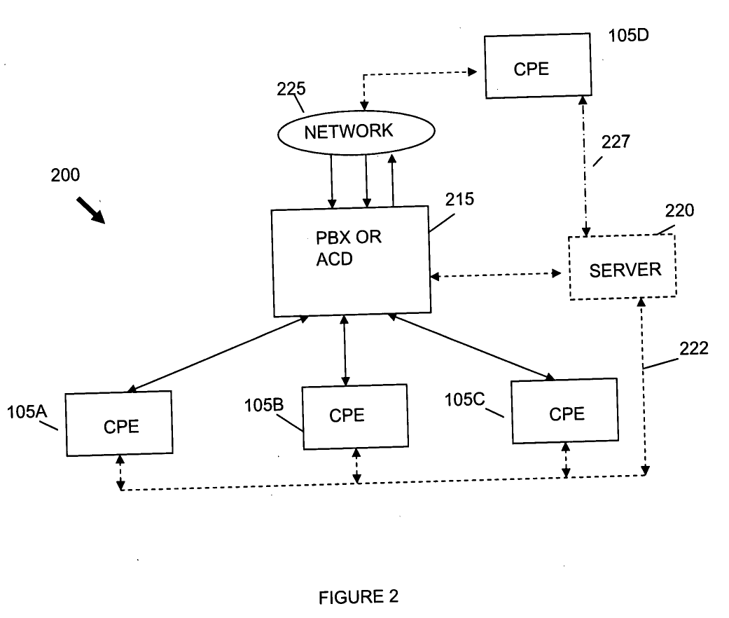

FIG. 2 is a block diagram of yet another exemplary environment of the invention, generally denoted by reference numeral 200, more adapted to the PBX environment. In this environment 200, a PBX 215 is shown interconnected with the CPEs 105A-105C. The PBX 215 may also include automatic call distributor (ACD) functionality that provides call center operations to agents associated with the CPEs 105A-105C. Alternatively, an optional server 220 may be employed in conjunction with the PBX 215 to provide the ACD functionality to the PBX and CPEs 105A-105C via network 222. The server 220 may also provide MCD download functionality to the CPEs 105A-105C. In alternate embodiments, the server 220 may also provide for storage and creation of MCD documents (pDoc) as information is made available during a MCD session by CPEs 105A-105D. Further, CPE 105D, which may be in functional communication with PBX 215 and CPEs 105A-105C during a communication session, perhaps by calling the call center represented by the PBX 215 with ACD functionality via phone network 225. In-band or out-of-band signaling may be employed to signal to CPE 105D. Optionally, CPE 105D may be in communication with the server 220 by a network 227 such as the Internet. The connectivity among components and devices may be accomplished by wireless technology also.

According to the principles of the invention, a conversation or call may be decomposed into electronic elements (E-elements), with each E-element directed to a portion of the conversation or call (or, possibly, the entire call). An E-element may include one or more multimedia components such as text, video, animation and/or audio. To capture information as defined by the E-elements from one or more participants during a call session, a template may be predefined that specifies one or more E-elements, hence specific expected information. During a call session, the template is processed such that information responsive to each defined E-element is solicited from the one or more participants and/or each participant's CPE (e.g., CPE 105A-105D). Although a template is used herein to explain the operations of MCD, it should be understood that the use of a template encompasses the use of scripting techniques (e.g., scripting languages) which is commonly known in the art. Furthermore, the format of a template may vary from the formats of the exemplary templates presented herein, as any one particular application of the invention warrants and/or one of ordinary skill in the art would recognize.

Each E-element of the template may be identified by a Tag, which identifies and corresponds to anticipated content of the E-element to be captured during the course of a call session. The E-elements and a corresponding Tag may be specified in a predefined template, as shown in a basic example of Table 1.

TABLE 1

Tag a: Template (Meeting Minutes)
Tag 0: generate doc-ID
Tag 1: date
Tag 2: name
Tag 3: title
Tag 4: minute

In the template of Table 1, the alphanumeric Tag identifier (in this case “Tag a”) provides the name of the template, which in this example is “Meeting Minutes.” The element denoted by “Tag 0” specifies that the document ID should be generated. The element denoted by “Tag 1” specifies that the current date should be provided. The element denoted by “Tag 2” specifies that names of session participants should be queried (which includes any forms of name such as audible or pictorial attributes available from session CPE profiles, described below). The element denoted by “Tag 3” specifies that a title of the resulting pDoc should be acquired, which may be acquired under moderator control, and may be text and/or audible input. The element denoted by “Tag 4” specifies that a minute entry (i.e., minutes of a meeting) should be acquired under moderator control which may be text or audible input.

Some tags may be standard tags according to an established tagging system while other tags maybe established at the discretion of the individual defining the template. The exemplary template of Table 1 is only one basic example; however, any number of elements may be defined and may be either automatically processed and/or “manually” controlled by a moderator. Elements may be created to capture nearly any type of information, either automatically from CPEs or manually from participants themselves. Further, security attributes may be applied to an element to control levels of security so that matching responses must meet or exceed the level of security specified by the template. For example, information contained in a CPE profile that is secured by a security level may only be accessed by a query with an appropriate equivalent security level number. The security processing may involve encryption and/or password techniques to protect the integrity of the security mechanisms, as is commonly known in the art.

The template may also be predefined to characterize various types of call situations. For example, one particular template may be predefined to reflect proceedings of a particular call center type call, perhaps related to a claims incident report, while another template may be created to reflect another type of call center call, perhaps related to product information. MCD may also be utilized for nearly any type of call situation, including but not limited to: corporate meetings, collaboration calls, business to business calls, professional-client calls, business to customer calls, personal calls and the like. In each of these call situations, there is typically information involved in the interchange that is a candidate for documenting.

A collection of E-elements as defined by a template is populated during the course of a conversation or session and represents a documented session, which is referred to as a pDoc (protocol document). The pDoc may be referred to by its identifier (i.e., a universal identifier such as a universal alphanumeric identifier). The pDoc may also be formatted to produce one or more documents that are compliant with importation rules of commonly known document processing programs such as word processors and spreadsheets, for example. The document(s) created by MCD may be distributed and shared. In this manner, a common document may be viewed or used by multiple participants, each having an identical copy. The pDoc may be created by one central device in the communication session or may be simultaneously created by each CPE in the session (or by any proxy associated with each CPE such as a server or controlling computer).

Table 2 is an example of a profile that may be defined at a CPE and may be checked during the course of MCD processing to provide information, perhaps automatically.

TABLE 2

[name] Martina; Martina_mp3; Martina.jpg
[phone] 911892
[address} 112 Mill St.
-SecurityLevel_7 - [CreditCard] Visa_xxxxxxxxx

The exemplary profile of Table 2 includes a “name” tag having three attributes including text “Martina”, a .mp3 file (audio) and a .jpg file (picture), all or some of which may be accessed to satisfy a request that has a tag of “name”. Likewise, tags for “phone,” “address” are defined. A security level of “7” has been applied to tag “CreditCard” which would prevent automatic access, for example, requiring user approval to access this secured information. A security mechanism may be provided that defines increments of security so that if a query has a particular level of security, then the query may automatically access a profile element with similarly assigned security level. Further, the CreditCard information (or any other information of a profile) may be encrypted. A profile may define nearly any type of information according to the tagging system of the MCD system.

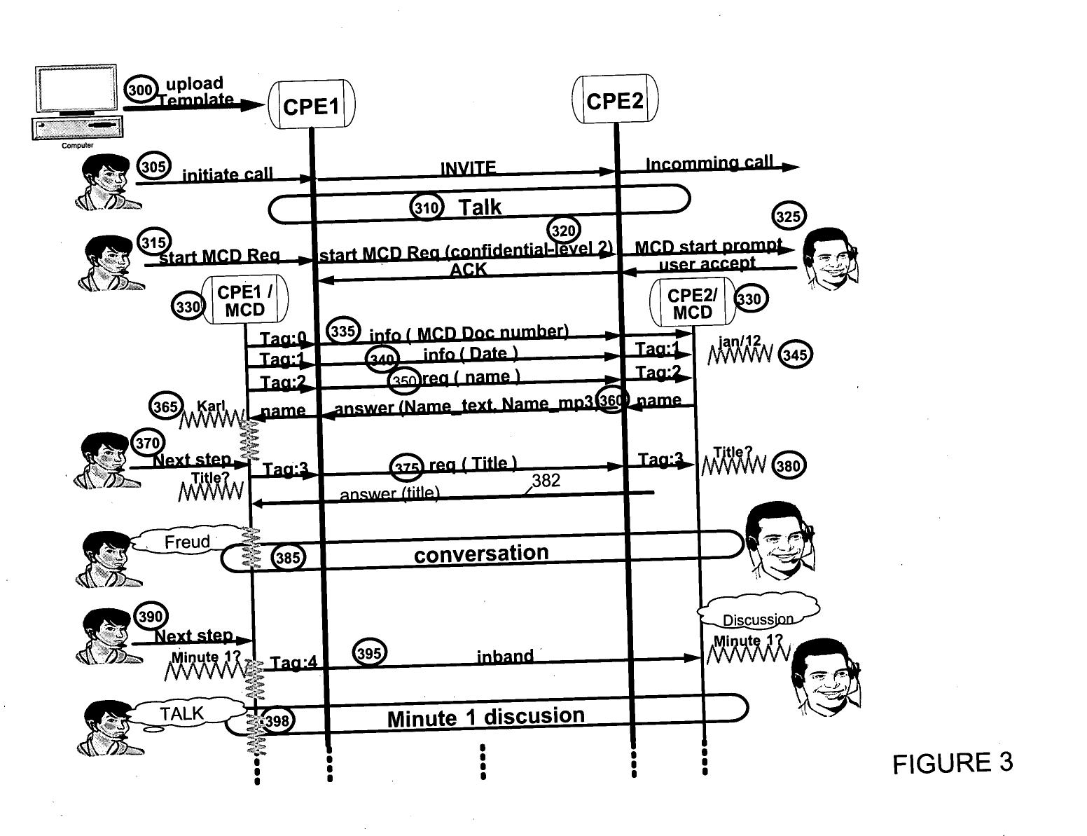

FIG. 3 is relational flow diagram showing a first embodiment of a process of documenting an illustrative call interchange, according to principles of the invention, starting at step 300. FIG. 3, as well as all other flow and relational flow diagrams herein, may equally represent a high-level block diagram of components of the invention implementing the steps thereof. The steps of FIG. 3, and all the other flow and relational flow diagrams herein, may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Further, the computer code may also be embodied, at least in part, in a medium such as a carrier wave, which can be extracted and processed by a computer. Additionally, the computer program code and any associated parametric data can be transferred to a workstation over the Internet or some other type of network, perhaps encrypted, using a browser and/or using a carrier wave. The steps of FIG. 3, as well as the other flow and relational flow diagrams herein, may also be implemented in the environments of FIGS. 1A, 1B and 2.

The relational flow diagram of FIG. 3 includes a simple call sequence for a call session between CPE1 and CPE2. However, any number of CPEs may participate in the session with similar parallel exchanges of query and response signaling among the participants. For simplicity of explanation, only two participants are shown. The information messages and replies are each recorded at CPE1 and/or each CPE in the session to form a pDoc. The information may include text, video, audio, pictorial or animation information, as appropriate. At step 300, a template may be uploaded to a CPE device, or, alternatively may be uploaded to a plurality of CPEs. The template may be used, when selected and started, to control documentation sequencing. At step 305, a call is initiated to one or more participants and an invitation to participate in a MCD session may be conveyed to the called participants. In this example, the user of CPE1 is a moderator of the session and typically controls the invitation and overall progress of the session. Although, in some embodiments, the invitation may be performed automatically by CPE1 and controlled automatically by CPE1. At step 310, any preliminary discussion or greetings may be exchanged among participants. At step 315, the moderator at CPE1 signals a “start MCD Request” to CPE2. This may occur when all participants give an indication that they are ready. At step 320, the “start MCD Request” is transmitted to CPE2 and includes a confidential parameter signifying that some data being requested may be confidential. At step 325, the “MCD Request” is translated according to a profile at CPE2 which may translate the request for display according to preferences established by the user of CPE2. For example, a date display may be altered to comply with formats preferred by the user of CPE2, or perhaps a language conversion is made as stipulated by the profile at CPE2.

At step 325, the user at CPE2 may be optionally prompted to supply a password to confirm that the user at CPE2 is indeed an authorized user thereby protecting against unauthorized use of the user's personal data contained in the profile, particularly if confidential data is contained in the profile. The CPE2 user then accepts the “start MCD Request,” perhaps by button press, which returns an acknowledgement to CPE1. At step 330, MCD logic is initialized at CPE1 and CPE2 and a selected template is retrieved, as selected by the moderator, or otherwise identified by a parameter, and processed by CPE1. Alternatively, the selected template may be processed by a software agent running remotely to CPE1 (e.g., at a server) which directs the processing operations of CPE1 by proxy communication.

At step 335, the initial element is retrieved from the template as indicated by “Tag 0” which includes a document identifier or document number which is to be associated with the pDoc being created. The document ID may be created dynamically, perhaps using time and date, for example, or otherwise, by a pre-determined document numbering practice. The template may also contain a predefined title, or a title may be developed dynamically during the session. The information message that includes the MCD document number is signaled to CPE2.

At step 340, the next element is processed, as indicated by element “Tag 1”, which signals the date to CPE2. The element may be marked that the date should be announced. Alternatively, only the Tag for date is signaled which infers that the current date should be recorded. At step 345, the date is audibly announced at CPE2, as may be specified by the current element and announced in accord with any specified date format defined by the profile at CPE2. At step 350, a query is issued to obtain the name from CPE2 based on element “Tag 2”. At step 360, CPE2 returns text information and/or picture/video information responsive to the query for the user's name, along with any pictorial information, such as a picture “.jpg” file or audible “.mp3” file. At step 365, the name as returned may be audible spoken and the supplied picture may be displayed. This returned information may be all recorded as part of the pDoc. At step 370, the template denoted by “Tag 3” indicates that a dynamic title is required and is dependent on the action of the moderator at CPE1 to acquire the title. At step 375, the moderator, in this example, audibly requests CPE2 to insert a title. At step 380, the user at CPE2 supplies a title. At step 382, a title is returned which may be audible. Alternatively, the reply may be text input, or could be supplied by the moderator directly.

At step 385, a discussion may ensue among session participants as necessary to deal with topics of the session. Optionally, this audible interchange may be recorded for translation from speech to text (or directly translated to text without audibly recording) which may become a part of the pDoc. At step 390, the moderator may be prompted by prompts to initiate the processing of the next element “Tag 4” to capture minutes of the session to which the info message for “Minute 1” may be signaled to CPE2 to be recorded as a header for “Minute 1” in the pdoc, or, the moderator may choose to request the minutes by inband discussion. At step 398, entry of any minutes for “Minute 1” (and any subsequent minutes) may be entered audibly or by text, as necessary. The MCD continues processing in this fashion until the moderator terminates the MCD function or otherwise the template is exhausted.

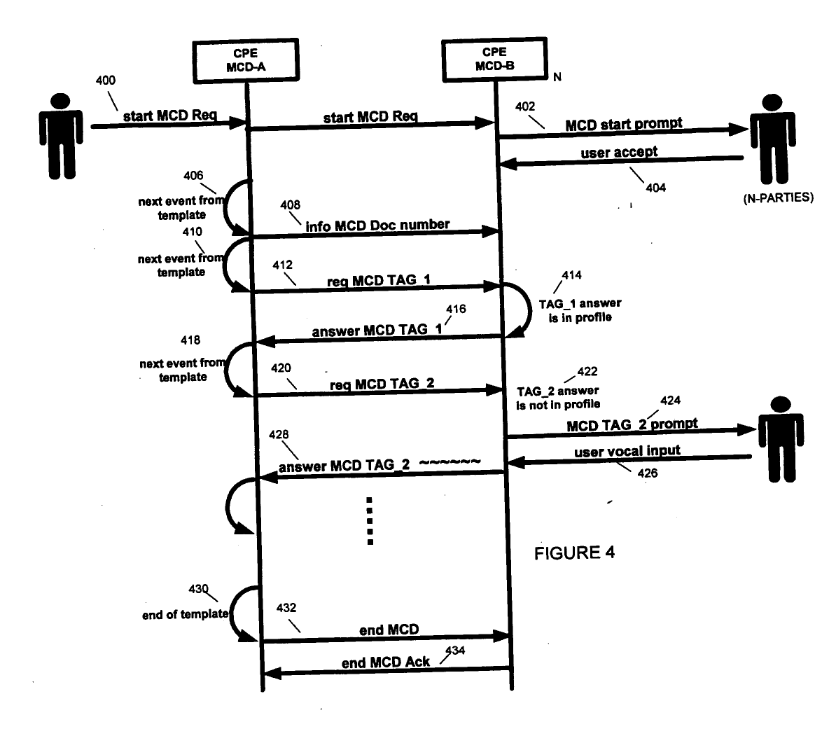

FIG. 4 is a relational flow diagram of a second embodiment of a process of documenting an illustrative call interchange, according to principles of the invention, starting at step 400. At step 400, a moderator at CPE MCD-A initiates MCD functionality by selecting a template and signaling a start MCD request to a second CPE, denoted by CPE MCD-B. There may be “N” number of CPEs with “N” parties involved in a session with similar signaling occur to the other “N” CPEs. For simplicity, signaling is shown to only the second CPE. At step 402, a MCD start prompt is provided to the user at CPE MCD-B. At step 404, a reply is returned accepting participation in the MCD session.

At step 406, the next element or event from the template is retrieved and processed. At step 408, an info message is signaled to CPE MCD-B that includes the MCD document number. At step 410, the next element or event is retrieved from the template. At step 412, a request (or query) may be signaled requesting MCD “Tag 1” information; “Tag 1” being specified in the template.

At step 414, a check determines that an answer to the request for “Tag 1” is in the profile at CPE MCD-B. At step 416, an answer or reply may be automatically returned (subject to any security restrictions). At step 418, the next event from the template is retrieved. At step 420, a request (or query) may be signaled for “Tag 2”. At step 422, a check determines that the answer is not available in the profile at CPE MCD-B. At step 424, the user is prompted (audibly or visually) at CPE MCD-B to provide the requested information. At step 426, the user provides vocal input responsive to the request for “Tag 2” (the user might also reply with multimedia content, if appropriate). At step 428, the answer is signaled to CPE MCD-A. At step 430, the end of the template is encounter and, at step 432, an “end MCD” message may be signaled. At step 434, an acknowledgement may be returned.

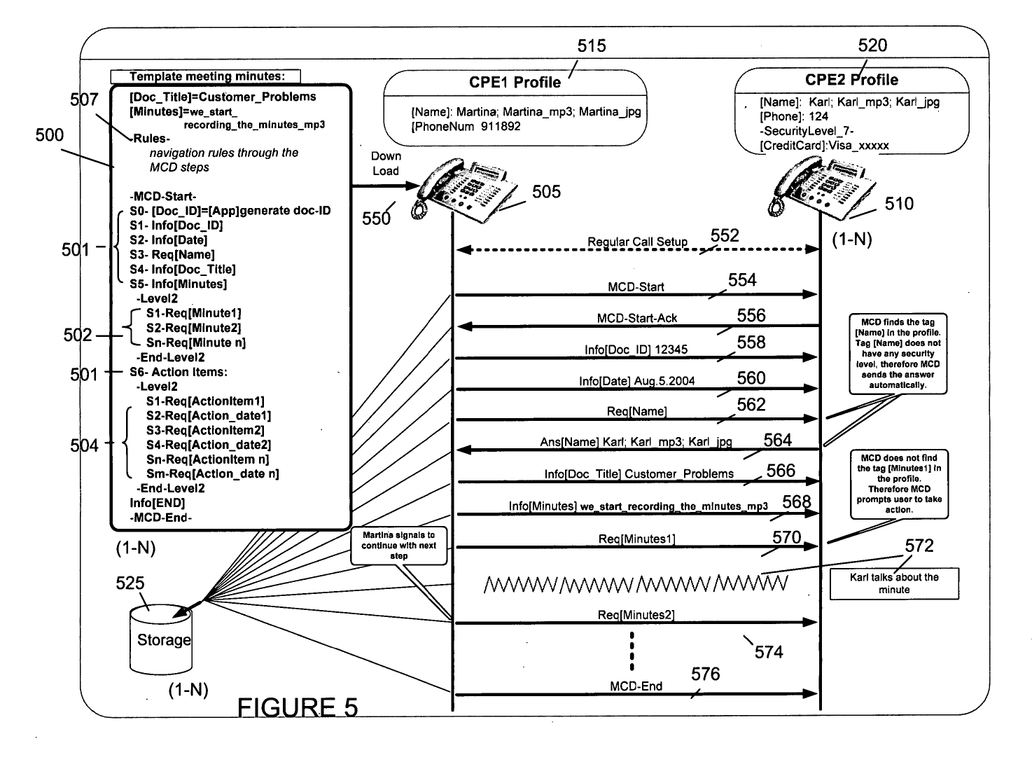

FIG. 5 is a relational flow diagram of a third embodiment of a process of documenting an illustrative call interchange, according to principles of the invention, starting at step 550. The relation flow diagram shows the relationships of a template 500 having a plurality of elements with tags, CPE1 505, CPE2 510, CPE1 profile 515, CPE2 profile 520 and storage 525. CPE1 profile 515 illustrates a profile having two elements with tags: “Name” and “PhoneNum.” CPE2 profile 520 illustrates a profile having three elements with tags: “Name,” “Phone” and “CreditCard.”

Templates 500 defines multiple step-elements S0-S6, 501, with elements S5 having several sub-elements S1-Sn, 502, and element S6 having several sub-elements S1-Sm, 504. Further, the template 500 also includes rules 507 that provide navigation rules for controlling the processing of the template 500. The rules may, for example, permit a user of CPE1 to skip certain steps (elements), or, to provide dependencies such that a step may be taken if a successful result of a previous step occurred. Or, steps may be skipped depending on results of certain steps. In this way, the rules provide flexibility to the flow of the template by providing conditional operation and/or provide for participant flexibility to navigate through the template (i.e., the moderator and/or each CPE user).

Also included in FIG. 5 is storage 525, which may be several storage devices 1-N, for storing the information signaled at various steps of the flow for creating a pdoc. The storage may be associated with CPE1 505 and/or CPE2 510, or associated with related servers such as 110A or 110B of FIG. 1A, or server 220 of FIG. 2.

Continuing with the process of FIG. 5, at step 550, a template and/or operational MCD software may be downloaded to CPE1 505. At step 552, a call may be established in a traditional manner. At step 554, an MCD start message may be provided to CPE2. At step 556, an acknowledgement may be returned indicating that MCD may be intimated for the call session. At step 558, the document ID may be signaled. At step 560, the date may be signaled. At step 562, a request is signaled for participant name(s). At step 564, a reply is automatically returned using the profile information of CPE2 profile 520.

At step 566, an information message is signaled with the document title “Customer_Problems.” At step 568, the info message for “Minutes” is signaled. Since this is not found in a profile, at step 570, a request for “Minutes_{—}1” is signaled. At step 572, the user, Karl, of CPE2 520 talks about the minute, which may be recorded, entered by text, or automatically transcribed (speech to text processing). At step 574, any additional minutes may be obtained in similar fashion, under control of the moderator at CPE1 505. At step 576, the moderator signals “MCD-End” which concludes the session. The pDoc may be stored in the one or more instances of storage 525 and may also be formatted for importation into commonly available software tools such as word processors or spreadsheets, according to importation rules for these tools.

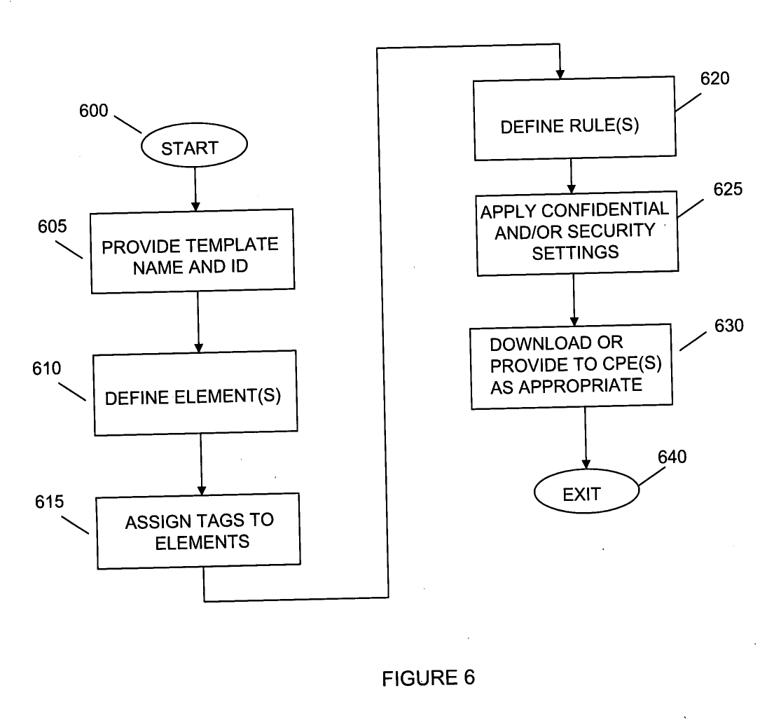

FIG. 6 is a flow diagram of steps for constructing a template, according to principles of the invention, starting at step 600. At step 605, a template name is created along with any optional identifier. At step 610, elements are defined for documenting a session. At step 615, tags may be assigned to the elements. The tagging system may be compliant with generally known hyper text markup language (html), extensible markup language (xml), or similar languages. At step 620, any rules may be defined to control the interpretation of the template thereby providing for conditional processing of the template and for specifying automatic or user control elements. At step 625, security levels may be applied to one or more elements. Encryption settings may also be specified to encrypt any messaging or informational parameters. At step 630, the template(s) may be provided to one or more CPE(s), as appropriate. At step 640, the process ends.

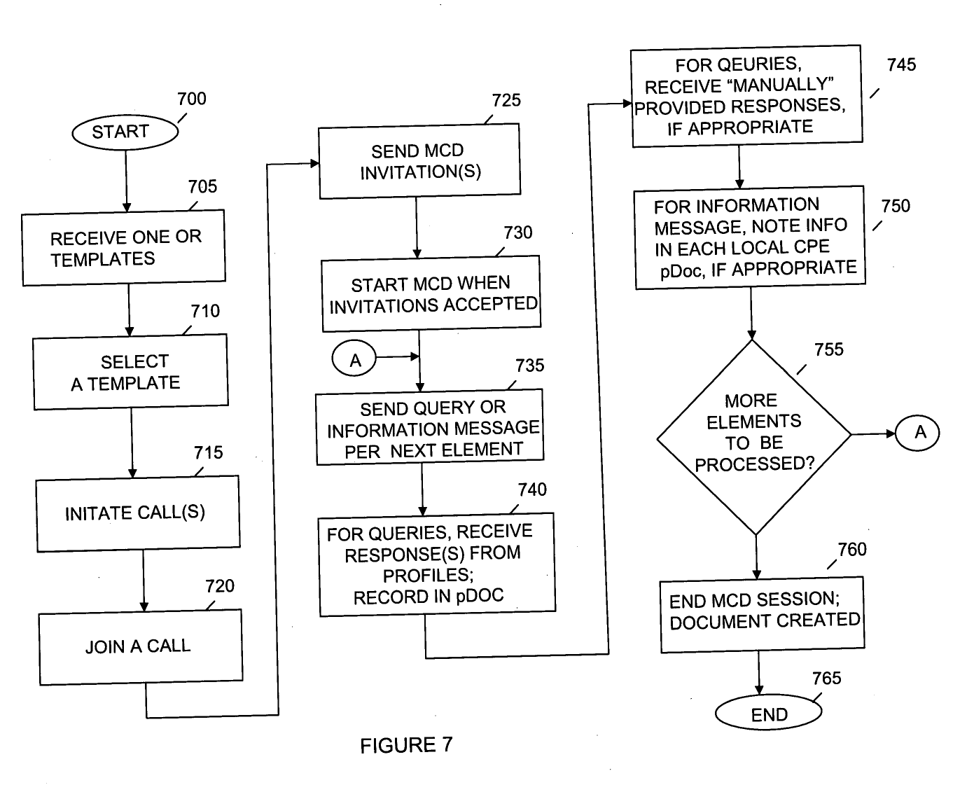

FIG. 7 is a flow diagram of an embodiment showing steps of documenting a communications session, according to principles of the invention, starting at step 700. At step 705, one or more templates may be received at a communication device. At step 710, one template may be selected for documenting a session. At step 715, a call or calls are initiated by usual practice and may be a conference call. At step 720, one or more participants join the session. At step 725, a MCD invitation is signaled to various devices in the session. At step 730, an MCD session may be initiated either automatically or by moderator control when one or more invitations are accepted.

At step 735, a query (i.e., request) or an information message may be sent per the next element of the template (which may be the first element). At step 740, for a query, a response (i.e., answer) is received from profiles in CPE(s) in the session. At step 745, if no suitable response is found. in the profiles of the CPEs in the session, a “manually” supplied response may be received. For a plurality of CPEs in the session, some answers may be automatic and some may be “manually” provided by users, depending on each CPE profile. The answers may become part of the pDoc and may include text, video, audio, animation and similar information.

At step 750, for information messages that are signaled, the information is noted in any instance of pDocs being created, as appropriate. That is, if the CPEs (or a subset of CPEs) in the session are each creating a pDoc, the information is recorded so that the information is the same at each pDoc. At step 755, a check is made whether there is another element to be processed in the template. If there is another element, then processing continues at step 735, with the next element while respecting any rules as defined by the template. At step 760, when no further elements remain to be processed, then an “End MCD” message may be sent. At step 765, the process ends.

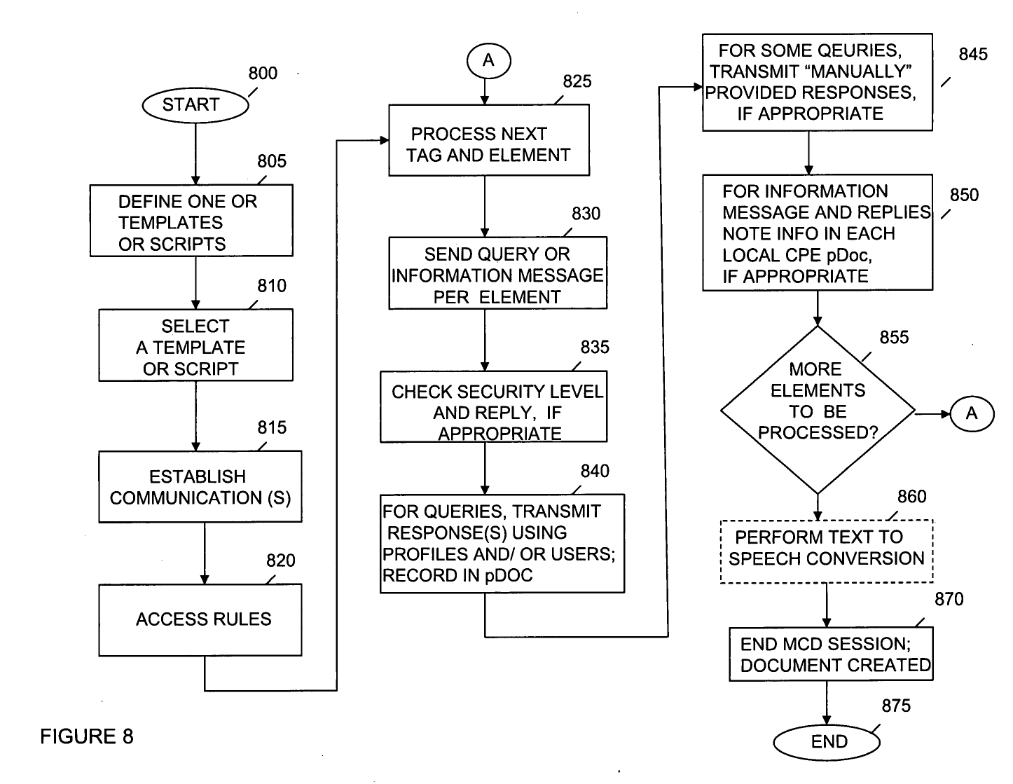

FIG. 8 is a flow diagram of another embodiment showing steps of documenting a communications session, according to principles of the invention, starting at step 800. At step 805, one or more templates or scripts may be defined. At step 810, a template or script is selected for documenting a communications session. At step 815, a communications session may be established. At step 820, security rules for controlling the access to elements and profile information may be defined. Further, rules to control element processing may be defined (i.e., conditional processing of elements). At step 825, the next element (or the first element, as appropriate) and tag is processed. At step 830, a query or information message with a tag may be sent for the element. At step 835, at the receiving CPE, a security level check of the query is made and if the security level for the information being requested is met, a reply is automatically prepared using profile information.

At step 840, transmission of the reply occurs with information recorded for building the pDoc. At step 845, if the profile is not able to provide information as requested by the tag, then, a user supplies the information responsive to the response. At step 850, for information messages and replies, the information provided by CPE(s) may be recorded in each CPE pDoc, if appropriate, and/or a centralized pDoc. At step 855, a check is made if another element requires processing. If another element requires processing, then processing continues with the next element at step 825. Otherwise, if no more elements require processing, then at optional step 860, speech-to-text conversion may occur for any audibly supplied information. At step 870, the MCD session ends with one or more instances of a pDoc created. The pDoc may be formatted using importation rules or specifications for other tools such as word processors or spreadsheets. At step 875, the process ends.

The pDoc is now created, adequately tagged and parameterized so that the contents may be indexed and may be searchable as an indexable resource, perhaps by search engines. The document may be searched, for example, by key words, names, dates, minutes, headings provided by tags, etc. This way historical information of communication sessions is now available for general use or dissemination.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A method for documenting a communications interchange, comprising:
providing to a first communications device a template defining at least one element for capturing information;
processing said template at said first communications device so that at least one query is issued to a second communications device based on said at least one defined element;
receiving at least one response to said at least one query including information responsive to said at least one defined element; and
creating a document based on said information received in said receiving step.

2. The method of claim 1, further comprising the step of assigning a unique tag to said at least one element.

3. The method according to claim 1, wherein said information responsive to the at least one defined element includes at least one of text information, video information, speech information, data information, and animation information.

4. The method according to claim 1 wherein said processing step includes iteratively issuing a plurality of queries based on a plurality of said elements.

5. The method according to claim 4, wherein said step for iteratively issuing is automatically performed by said first communications device, which comprises a telecommunications device.

6. The method according to claim 1 wherein said step of processing is performed under direction of a user of said first communications device so that timing of at least a subset of the plurality of queries is controlled by a user of said first communications device.

7. The method of claim 1, wherein said template defines a sequence for issuing the at least one query based on said defined at least one element.

8. The method of claim 1, wherein said step of processing includes at least one query that includes a tag interpretable at said second communications device.

9. The method of claim 1, wherein the communications interchange includes telephonic interchange and said providing step includes downloading said template to said first communications device.

10. The method of claim 1, wherein said step of receiving at least one response comprises a plurality of responses and further comprising the steps of:
assembling said information provided by said plurality of responses to create a historical record of said communications interchange; and
formatting said historical record according to importation rules.

11. A method for documenting a communication session, comprising:
receiving at a first communications device a multimedia conversation documenter (MCD) invitation request;
sending to a second communications device an acknowledgement to said MCD invitation request accepting participation in documenting the communication session;
receiving at said first communication device a query that includes a tag that identifies an element; and
issuing to said second communications device a reply to said query that includes information relevant to said element.

12. The method according to claim 11, wherein said information includes at least one of text information, video information, photo information, data information, speech information and animation information.

13. The method according to claim 11, wherein said acknowledgement is controlled by a user of said first communications device.

14. The method according to claim 11, further comprising automatically responding to said query by providing information identified by said tag.

15. The method of claim 11, wherein at least one of said MCD invitation request, acknowledgement, query, and information is encrypted and said acknowledgement is password controlled.

16. A system for documenting a communications session comprising:
a first communication device that issues at least one query according to a template that defines at least one element for requesting and acquiring information during said communications session, said at least one query including at least one tag indicative of a type of information being requested; and
a second communications device to translate said at least one query and return information corresponding to said at least one element during said communications session.

17. The system of claim 16, further comprising a template constructor to construct said template, said template having said at least one element and said constructor configured to assign said tag to said at least one element.

18. The system of claim 16, wherein said template is compliant with at least one of hyper-text markup language (html) and extensible markup language (xml).

19. The system according to claim 16, wherein said first communications device accumulates said returned information to construct a document indexable by said at least one tag wherein said information and said at least one tag are correlated.

20. The system according to claim 16, wherein said second communications device translates said at least one query according to a profile maintained by said second communications device.
